(19) United States
(12) Patent Application Publication
(10) Pub. No.: US 2013/0100200 A1
(43) Pub. Date: Apr. 25, 2013

(54) INKJET PRINTING APPARATUS AND PRELIMINARY EJECTION METHOD

(71) Applicant: CANON KABUSHIKI KAISHA, Tokyo (JP)

(72) Inventors: Yuji Hamasaki, Kawasaki-shi (JP); Atsushi Takahashi, Kawasaki-shi (JP); Takuya Fukasawa, Kawasaki-shi (JP)

(73) Assignee: CANON KABUSHIKI KAISHA, Tokyo (JP)

(21) Appl. No.: 13/651,629

(22) Filed: Oct. 15, 2012

(30) Foreign Application Priority Data
Oct. 21, 2011 (JP) 2011-231279

(51) Int. Cl. B41J 2/165

(52) U.S. Cl. 347/23

(57) ABSTRACT

In a case where a temperature of the print head at a cap closing time is 35° C. or more and the cap closing time is less than six hours, a predetermined preliminary ejection is performed and the ejection number is set to 4000. That is, the predetermined preliminary ejection is, in a case where it is determined that the temperature of the print head at a cap closed time is lower than 35° C., performed by the ejection number larger than the ejection number of other preliminary ejection having the same cap closing time of six hours as that in the predetermined preliminary ejection. Therefore in a case where the temperature of the print head at a cap closing time is a predetermined relatively high temperature or more, the preliminary ejection more accurately reflecting the degree of the ink thickening in the print head at that time is performed.

### BACKGROUND OF THE INVENTION

1. Field of the Invention

The present invention relates to an inkjet printing apparatus and a preliminary ejection method of a print head, and particularly, to a technique for controlling a content of a preliminary ejection in consideration of a capping time of a print head. It should be noted that an inkjet printing apparatus in the present invention can be applied to an inkjet printer, and besides, a facsimile, copier, a complex machine, and the like, which use an inkjet printing method.

2. Description of the Related Art

In the inkjet printing apparatus, when s state where a printing operation is not performed continues, a cap is placed to make contact with a surface of a print head on which nozzles for ejecting ink are arranged, thereby covering the surface (hereinafter, called also “capping the surface”). With this capping, ink in the nozzle or inside the nozzle can be prevented from increasing viscosity and drying. In addition, after the capping, a preliminary ejection which is an ink ejection not involved in printing in the print head is performed, thereby removing a relatively slight increased viscosity of ink which may possibly be generated during the capping.

In regard to this preliminary ejection after the capping, the preliminary ejection is performed on the basis of the ejection number of the preliminary ejections depending upon the capping time (hereinafter, cap closed time) or the like. Therefore, it is possible to perform the preliminary ejection in accordance with the degree of the viscosity increasing of ink which may be generated during the cap closing time.

In addition, generally as to a condition of performing a preliminary ejection, Japanese Patent Laid-Open No. H10-202903(1998) describes a method for determining the ejection number of times, an ejection frequency and an ejection interval of the preliminary ejection, and ink nozzles as a target, based upon an ink remaining amount in an ink tank, an environment temperature, humidity, an atmospheric pressure, and the like.

However, the inventors of this application have found out that, in a case where a temperature of the print head before being closed with the cap is high, even if the content of the preliminary ejection is controlled based upon the aforementioned cap-closing time, there is a possibility that an ejection failure of the ink is caused. For example, after a printing operation is continuously performed for a relatively long time, the cap closing is performed. Afterward, when the preliminary ejection is performed to restart the printing operation, the ejection failure may possibly be caused. More specifically, the temperature of the print head becomes high due to the above continued printing operation, which adversely affects an ejection state of the print head. Therefore the ejection failure may possibly be caused in a case of performing the preliminary ejection based upon the cap closing time alone.

On the contrary, depending on a temperature of the print head before being closed with the cap, in a case where the cap closing time is relatively short, in some cases the ejection number of the times of the preliminary ejections determined based upon the cap closing time becomes excessively large. As a result, there occurs another problem that unnecessary ink consumption is made.

As described above, in a case of performing the preliminary ejection based upon the cap closing time, there occurs a problem that it is difficult to perform the preliminary ejection of appropriately reflecting a state of the print head.

### SUMMARY OF THE INVENTION

An object of the present invention is to provide an inkjet printing apparatus and a preliminary ejection method which can perform a preliminary ejection of appropriately reflecting a state of a print head in the structure of performing the preliminary ejection at a cap opening time.

In a first aspect of the present invention, there is provided an ink jet printing apparatus having a print head including an ejection opening surface on which a nozzle for ejecting ink is provided, a cap for capping the ejection opening surface, and a preliminary ejection unit configured to cause the print head to eject ink after disengaging the cap from the ejection opening surface, the apparatus comprising: a control unit configured to control the preliminary ejection unit based on time of capping the ejection opening surface with the cap and temperature of the print head before capping the ejection opening surface with the cap.

In a second aspect of the present invention, there is provided a preliminary ejection method for an ink jet printing apparatus having a print head including an ejection opening surface on which a nozzle for ejecting ink is provided, a cap for capping the ejection opening surface, and a preliminary ejection unit configured to cause the print head to eject ink after disengaging the cap from the ejection opening surface, the method comprising: a temperature measuring step of measuring temperature of the print head before capping the ejection opening surface with the cap; a time measuring step of measuring time of capping the ejection opening surface with the cap; and a control step of controlling the preliminary ejection unit based on the temperature of the print head measured in the temperature measuring step and the time of capping measured in the time measuring step.

According to the above structure, it is possible to perform the preliminary ejection of appropriately reflecting the state of the print head in the structure of performing the preliminary ejection at a cap opening time.

Further features of the present invention will become apparent from the following description of exemplary embodiments (with reference to the attached drawings).

### BRIEF DESCRIPTION OF THE DRAWINGS

FIG. 1 is a perspective view showing a mechanical structure of an essential part in an inkjet printing apparatus according to an embodiment of the present invention;

FIG. 2 is a perspective view showing a print head and an ink tank according to the embodiment in the present invention;

FIG. 3 is a block diagram showing a schematic configuration of a control system in the inkjet printing apparatus shown in FIG. 1;

FIG. 4 is a flow chart showing a preliminary ejection process according to a first embodiment in the present invention;

FIG. 5 is a diagram showing a relation between a cap closing time and the ejection number of times of ejections per one nozzle in a preliminary ejection according to the first embodiment in the present invention;

FIG. 6 is a flow chart showing a preliminary ejection process at a cap opening time according to a second embodiment in the present invention; and

FIG. 7 is a flow chart showing a preliminary ejection process at a cap opening time according to a third embodiment in the present invention.

### DESCRIPTION OF THE EMBODIMENTS

Hereinafter, embodiments of the present invention will be in detail explained with reference to the accompanying drawings.

### (Structure of Inkjet Printing Apparatus)

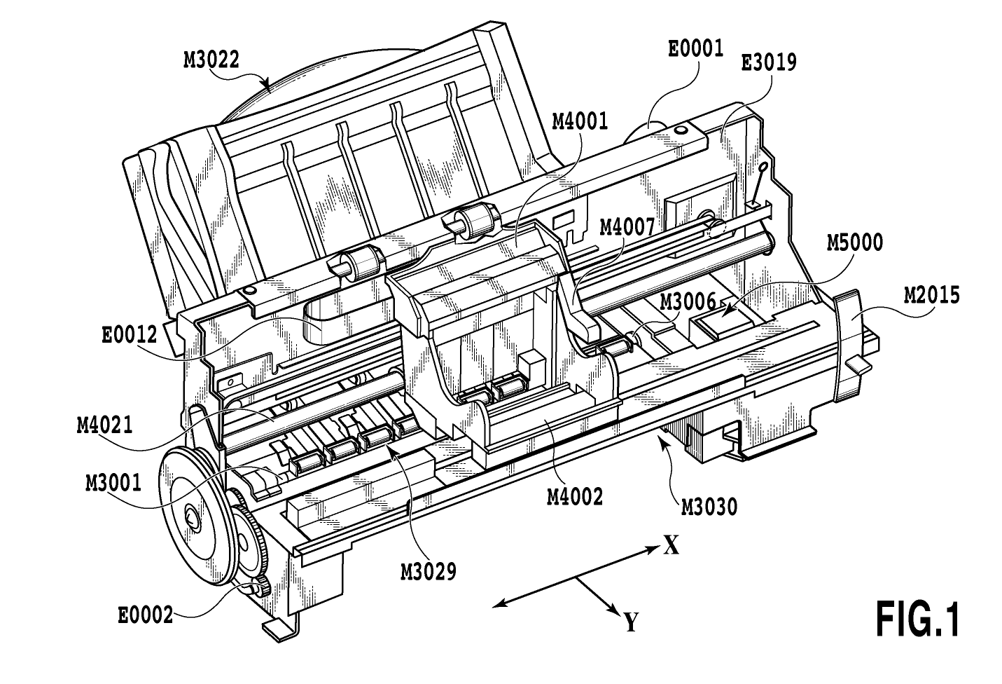

FIG. 1 is a perspective view showing a mechanical structure of an essential part in an inkjet printing apparatus according to an embodiment of the present invention. In FIG. 1, a chassis M3019 accommodated in an exterior member in the printing apparatus is structured by a plurality of plate-shaped metallic members, forms part of a skeleton in the printing apparatus, and holds each printing operation mechanism as follows. An automatic feeding unit M3022 automatically feeds a sheet (print medium) inside the apparatus body. A conveying unit M3029 conveys the sheet fed out one by one from the automatic feeding unit M3022 to a predetermined printing position, and also conveys the sheet from the printing position to a discharge unit M3030. The conveying direction of this sheet (sub scan direction) is shown by an arrow Y in the figure. Desired printing is performed on the sheet conveyed to the printing position by a printing unit. A recovery operation is executed for the printing unit by a recovery unit M5000. Reference sign M2015 denotes a sheet-head distance adjusting lever, and Reference sign M3006 denotes a bearing of an LF roller M3001. In the printing unit, a carriage M4001 is movably supported in a main scan direction of an arrow X by a carriage shaft M4021. In the carriage M4001, a print head H1001 capable of ejecting ink is removably installed.

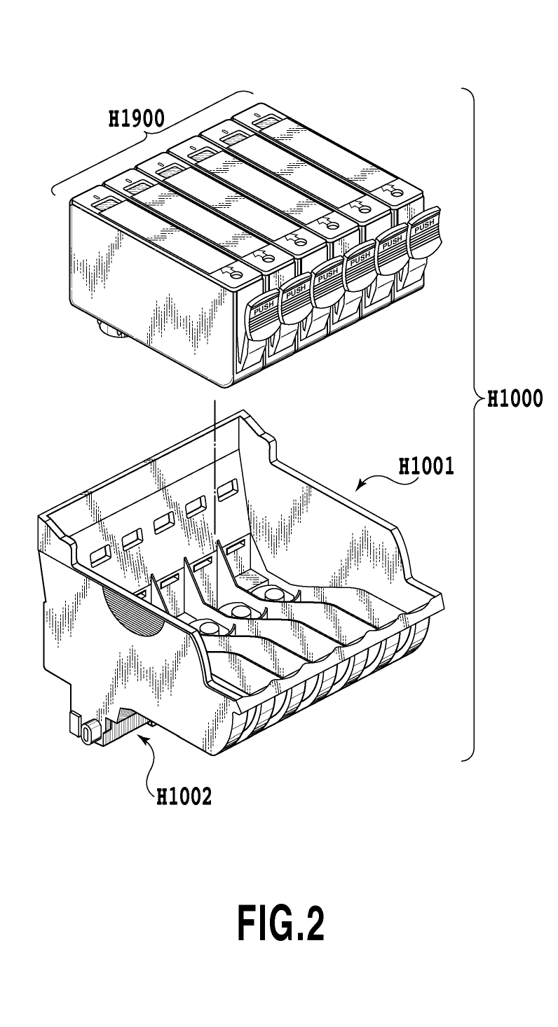

FIG. 2 is a perspective view showing the print head H1001 and an ink tank H1900. As a shown in FIG. 2, the print head H1001 constitutes a print head cartridge H1000 together with the ink tank H1900 reserving ink therein. As to the ink tank H1900, for enabling color printing with high image quality as similar to a photograph, for example, there are prepared independent ink tanks corresponding to the respective colors of black (Bk), light cyan (LC), light magenta (LM), cyan (C), magenta (M), and yellow (Y) of pigments. The ink tanks H1900 respectively are removably mounted to the print head H1001. The print head H1001 obtains head drive signals based upon print data from the printing apparatus. An ink ejection unit H1002 in the print head H1001 is provided with nozzle rows for ejecting inks of Bk, LC, LM, C, M, and Y respectively, and an electro-thermal conversion element is provided to correspond to each nozzle therein. Heat generation in the electro-thermal conversion element causes film boiling in ink, and the ink can be ejected from the corresponding nozzle by the foaming energy at this time. In addition, a temperature detecting element for detecting a temperature of the print head is provided in the ejection unit H1002 in the print head.

The recovery unit M5000 is provided with a cap (not shown) making contact with a surface (ejection opening surface) in the print head H1001 on which a nozzle row of each color ink is provided. This cap is connected to a suction pump capable of introducing a vacuum into the cap. Therefore the vacuum can be introduced into the cap covering the ink ejection opening (nozzle) in the print head H1001 to suction and discharge ink from the ink ejection opening and thus the recovery operation for maintaining an appropriate ink ejection condition of the print head H1001 is executed. Further, a preliminary ejection of the print head, which will be explained in each embodiment to be described later, is performed into the cap.

In addition, the carriage M4001 is, as shown in FIG. 1, provided with a carriage cover M4002 for guiding the print head H1001 to a predetermined mount position above the carriage M4001. Further, the carriage M4001 is provided with a head set lever M4007 which is engaged to a tank holder in the print head H1001 to set the print head H1001 to a predetermined mount position. The head set lever M4007 is provided to be rotatable to a head set lever shaft positioned above the carriage M4001, and an engaging portion thereof engaging to the print head H1001 is provided with a spring-urged head set plate (not shown). The head set lever M4007 presses the print head H1001 by its spring force, while being mounted to the carriage M4001.

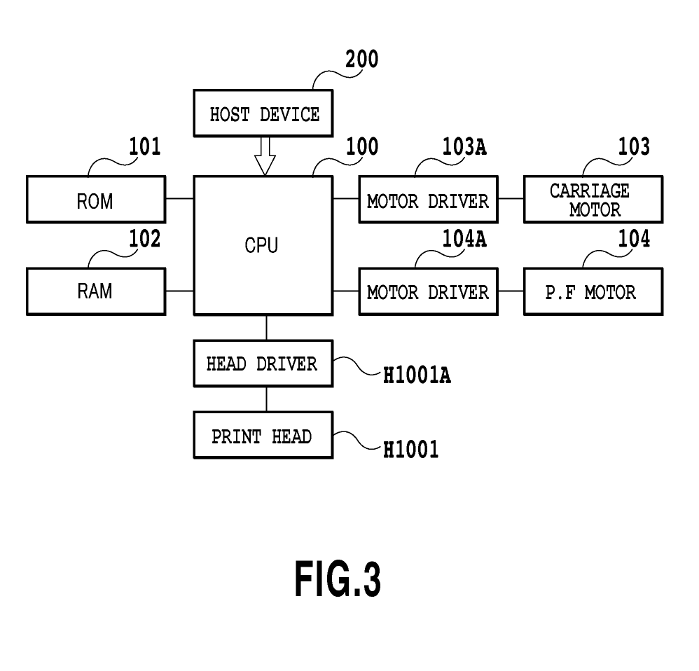

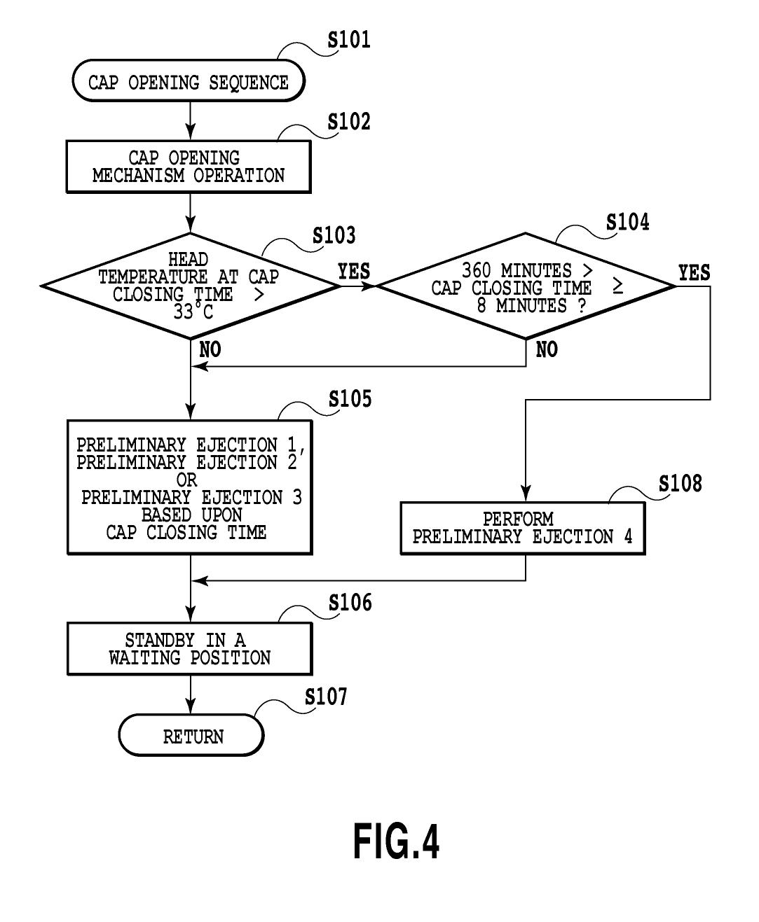

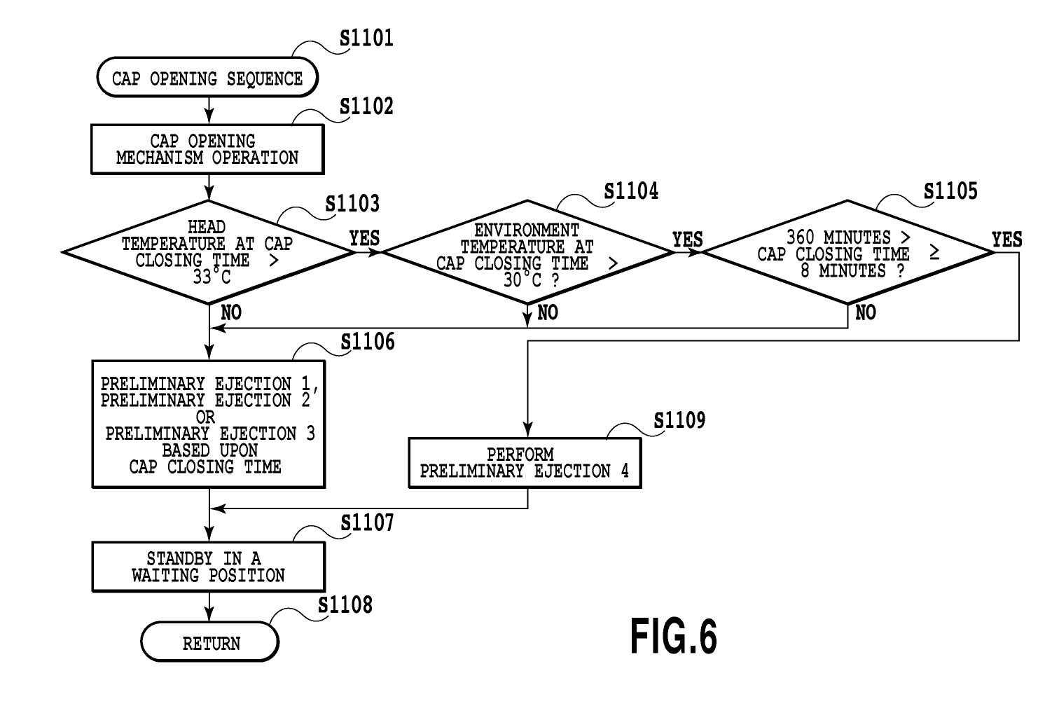

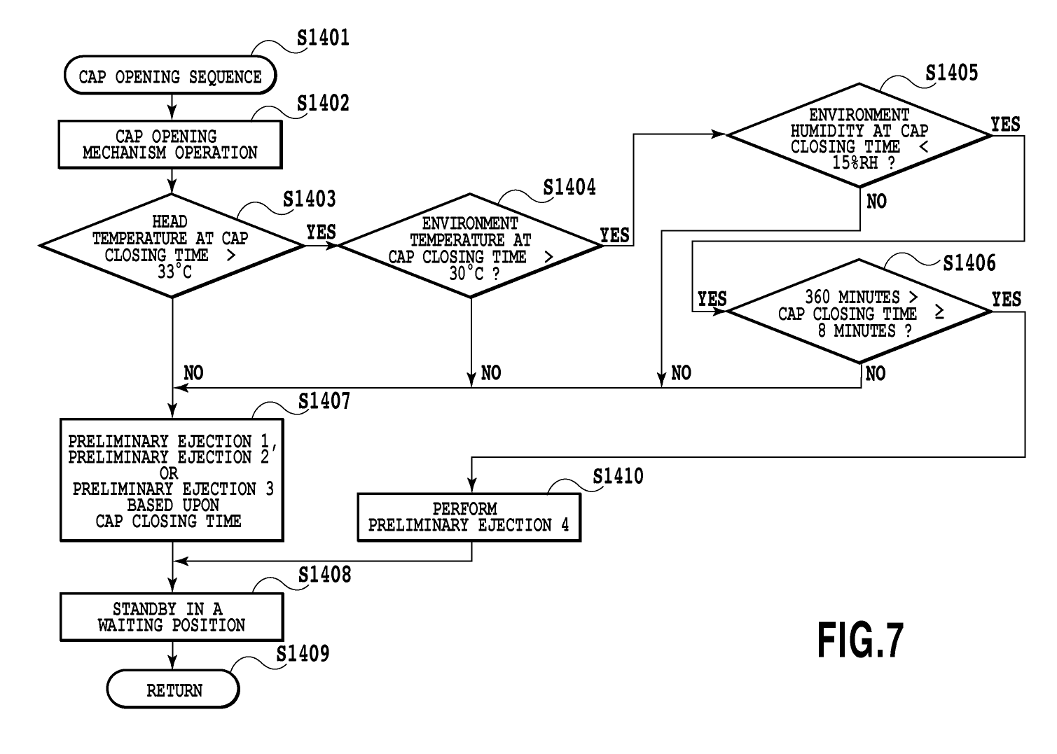

FIG. 3 is a block diagram showing a schematic configuration of a control system in the inkjet printing apparatus shown in FIG. 1. In FIG. 3, a CPU 100 executes control processing of the operation, data processing, and the like in the present printing apparatus. A ROM 101 stores programs of the processing procedures thereof and the like, and a RAM 102 is used as a work area for executing the processing. In addition, the CPU 100 uses a temperature of the print head detected by the temperature detecting element of the print head to execute the control and the processing according to a processing program in regard to the preliminary ejection to be described later in each of FIG. 4, FIG. 6 and FIG. 7.

The ejection of ink from the print head H1001 is performed by supply of drive data (print data) and a drive control signal (heat pulse signal) of the electro-thermal conversion element or the like to a head driver H1001A by the CPU 100. The CPU 100 controls a carriage motor 103 for driving the carriage M4001 in a main scan direction through a motor driver 103A, and controls a P.F motor 104 for conveying a sheet in a sub scan direction through a motor driver 104A.

In a case of performing printing by the inkjet printing apparatus as structured above, first, the print data transmitted through an external I/F from a host device 200 (refer to FIG. 3) is once stored in a printing buffer. In addition, the carriage motor 103 causes the print head H1001 together with the carriage M4001 to be moved in a main scan direction. In addition, a printing operation of ejecting ink based upon the print data from the print head H1001 and a conveying operation of conveying a sheet by a predetermined amount in the sub scan direction by the P. F motor 104 are repeated to sequentially print an image on the sheet.

Embodiments of the ejection recovery operation by the preliminary ejection in the inkjet printing apparatus explained above will be hereinafter explained.

### First Embodiment

FIG. 4 is a flow chart showing a preliminary ejection process according to a first embodiment of the present invention, and shows the process at the time of disengaging the cap from the print head (a cap opening). In the inkjet printing apparatus, when a predetermined operation is activated after a cap closing (cap contacted) state, at step S101 the cap opening sequence starts. This process is activated at an application of power and in a case where input of a print signal is performed at or at a capped, waiting state.

In this process, first at step S102 a cap opening operation of a mechanism portion in the printing apparatus starts. Next, at step S103, when a cap being closed before activating the present process, a temperature of the print head measured immediately before becoming the cap closing state is obtained, which is compared with a predetermined threshold T° C., 33° C. in the present example.

As a result of the comparison, in a case where the temperature of the print head is the predetermined threshold T° C. or less, at step S105 any of Preliminary ejection 1, Preliminary ejection 2, and Preliminary ejection 3 is selected based upon the result of the time measurement of the cap closing time (the capping time) and the selected preliminary ejection is performed.

In the present example, the ejection number of times in the preliminary ejection per one nozzle determined based upon the cap closing time is as follows.

Preliminary ejection 1: 1000 times of ejections/cap closing time is less than six hours.

Preliminary ejection 2: 5000 times of ejections/cap closing time is six hours or more and is less than 24 hours.

Preliminary ejection 3: 10000 times of ejections/cap closing time is 24 hours or more.

In a case where at step S103 it is determined that the head temperature is higher than the predetermined threshold temperature T° C. as a result of comparison between the predetermined threshold T° C. and the head temperature, the process goes to step S104, wherein it is determined whether or not a condition that t1 (eight minutes in this example)<the cap closing time<t2 (360 minutes in this example) is satisfied. In a case where the condition is not satisfied, the process goes to step S105, wherein as similar to the above description, any of Preliminary ejection 1, Preliminary ejection 2, and Preliminary ejection 3 is selected based upon the result of the time measurement of the cap closing time and the selected preliminary ejection is performed.

Then, at step S106 the print head is positioned to a waiting position to be in a waiting state, and at step S107 the present process ends. Thereafter the printing operation starts.

As a result of determination at step S104, in a case where the condition is satisfied, that is, the cap closing time is eight minutes or more and less than six hours, the process goes to step S108, wherein Preliminary ejection 4 is performed. The Preliminary ejection 4 is set in such a manner that the ejection number per one nozzle is larger than that in the Preliminary ejection 1. In the present example, the Preliminary ejection 4 is set as follows.

Preliminary ejection 4: 4000 times of ejections/the cap closing time is eight minutes or more and less than six hours.

In a case where the print head temperature before being closed with the cap is the predetermined temperature or more, the above preliminary ejection control can overcome a problem causing a defect in the ink ejection in a relatively short time.

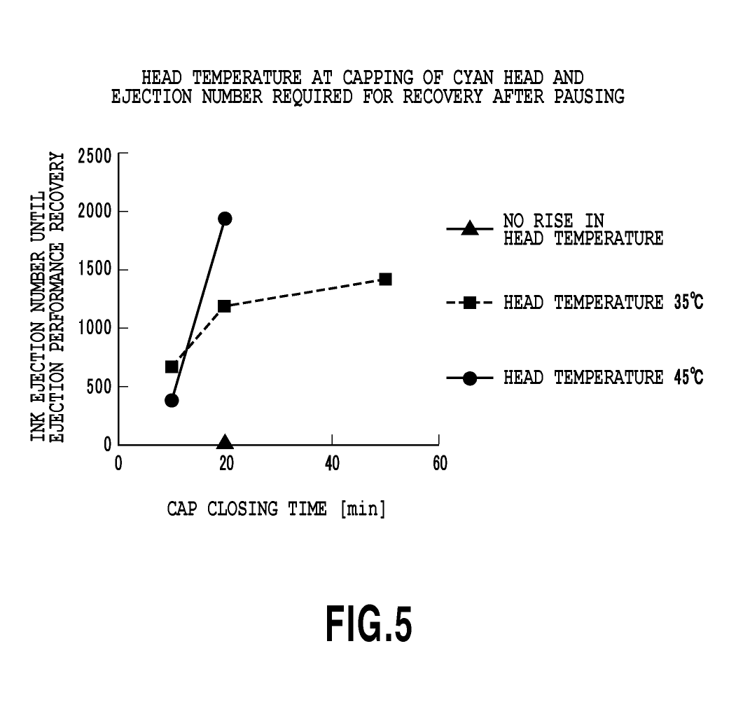

FIG. 5 is a diagram showing a relation between a cap closing time and an ejection number of times per one nozzle as an example, and shows a state where the cap closing time is less than six hours, that is, a range where the aforementioned “Preliminary ejection 1” can be selected. As shown in FIG. 5, for example, in a case where a temperature T of the print head before being closed with the cap is 35° C. or more (35° C. or 45° C.), the ejection number required for recovery becomes 1000 times of ejections as the ejection number of the Preliminary ejection 1 in a relatively short time (about 15 minutes or about 18 minutes). From this point of view, in the present embodiment, in a case where the temperature T of the print head before being closed with the cap is 35° C. or more (S103) and the cap closing time is less than six hours (S104), the Preliminary ejection 4 is performed and the ejection number is set to 4000 (S108). That is, the Preliminary ejection 4 is performed by the ejection number larger than the ejection number of the Preliminary ejection 1, which has the same cap closing time of six hours as that in the preliminary ejection 4 and is performed in a case where it is determined that the temperature T of the print head before being closed with the cap is lower than 35° C. (S103). Therefore in a case where the temperature of the print head at a cap closing time is the predetermined high temperature or more, the preliminary ejection more accurately reflecting the degree of increased viscosity of the ink in the print head at that time is performed, making it possible to prevent occurrence of the ejection failure by the cap closed for a relatively short time.

Assuming that a relatively large ejection number (more than 1000) is set in the Preliminary ejection 1, the preliminary ejection having a large ejection number is performed for each printing operation. That is, in a use situation for a user to use the inkjet printing apparatus relatively frequently in the cap closing time of less than six hours, the preliminary ejection of a large ejection number is resultantly performed for each printing operation, and therefore unnecessary ink is consumed. On the other hand, in the present embodiment, by setting an appropriate ejection number (1000), the defect of the ink ejection can be prevented and the ink consumption by the preliminary ejection can be suppressed.

In the above example, the method by comparison using the temperature threshold T of the print head is explained for defining the content of the preliminary ejection, but a table for defining the ejection number of the preliminary ejection for each head temperature may be used.

In addition, as an example for changing the content of the preliminary ejection, changing the ejection number is explained, but for example, a voltage of a pulse applied to an electro-thermal conversion element at ink ejecting in the Preliminary ejection 4 may be set to be higher than that of each of the Preliminary ejections 1, 2 and 3. As a result, the ejection energy of the Preliminary ejection 4 can be increased to make the nozzle recovery performance higher than that of each of the Preliminary ejections 1, 2 and 3. For example,

Preliminary ejections 1, 2 and 3: the drive voltage is 24V.

Preliminary ejection 4: the drive voltage is 26.2V.

In addition, an applying time of a pulse (pulse width) applied to an electro-thermal conversion element at ink ejecting in the Preliminary ejection 4 may be set to be larger than that of each of the Preliminary ejections 1, 2 and 3. For example,

Preliminary ejections 1, 2 and 3: the voltage applying time is 0.9 μs.

Preliminary ejection 4: the voltage applying time is 0.98 μs.

Further, the ejection frequency in the Preliminary ejection 4 may be set to be higher than that of each of the Preliminary ejections 1, 2 and 3. For example,

Preliminary ejections 1, 2 and 3: the ink ejection frequency is 15 kHz.

Preliminary ejection 4: the ink ejection frequency is 20 kHz.

### Second Embodiment

FIG. 6 is a flow chart showing a preliminary ejection process at a cap opening time according to a second embodiment of the present invention. The present embodiment relates to a configuration of determining a content of a preliminary ejection in consideration of a temperature of the print head at a cap closing time, and also of an environment temperature at that time.

In FIG. 6, the process from step S1101 to step S1103 is similar to that from step S101 to step S103 shown in FIG. 4 according to the first embodiment, and the process after step S1106 in a case where the negative determination is made at step S1103 is also similar to that after step S105 shown in FIG. 4.

The content of each of the Preliminary ejection 1, the preliminary ejection 2, and the Preliminary ejection 3 selected based upon the cap closing time at step S1106 is the same as that of the first embodiment, and is as follows.

Preliminary ejection 1: 1000 times of ejections/cap closing time is less than six hours.

Preliminary ejection 2: 5000 times of ejections/cap closing time is six hours or more and less than 24 hours

Preliminary ejection 3: 10000 times of ejections/cap closing time is 24 hours or more.

In a case where at step S1103 as a result of comparison between a threshold T° C., which is 33° C. in the present embodiment, and a temperature of the print head at a cap closing time, it is determined that the temperature of the print head is higher than the predetermined temperature T° C., the process goes to step S1104, wherein it is determined whether or not an environment temperature at a cap closing time is higher than a predetermined threshold Te° C., for example, 30° C. In a case where the environment temperature is less than the threshold Te° C., the process goes to step S1106. On the other hand, in a case where the environment temperature is higher than the threshold Te° C., the process goes to step S1105, wherein it is determined whether or not a condition that t1 (eight minutes in this example)<cap closing time<t2 (360 minutes in this example) is satisfied. In a case where the condition is not satisfied, the process goes to step S1106.

In a case where the determination condition at step S105 is satisfied, the process goes to step S1109, wherein the Preliminary ejection 4 is performed. Here, the Preliminary ejection 4 is set in such a manner that the ejection number is larger than that in the Preliminary ejection 1 in the same way as the first embodiment. That is,

Preliminary ejection 4: 4000 times of ejections/the cap closing time is eight minutes or more and less than six hours.

As described above, according to the present embodiment, in a case where the temperature of the print head before being closed with the cap is the predetermined high temperature or more and the environment temperature at that time is also the predetermined temperature or more, the preliminary ejection (Preliminary ejection 4) more accurately reflecting the degree of increased viscosity of the ink in the print head at that time can be performed. As a result, it is possible to prevent occurrence of the ejection failure by the cap closed for a relatively short time.

It should be noted that in the present embodiment also, a table for defining the ejection number of the preliminary ejection for each combination of the head temperature and the environment temperature may be used.

In the same way as the explanation in the first embodiment, in regard to the Preliminary ejection 4, a voltage value or a pulse width of a pulse applied to the electro-thermal conversion element may be made large or an ejection frequency may be made high.

### Third Embodiment

FIG. 7 is a flowchart showing a preliminary ejection process at a cap opening time according to a third embodiment of the present invention. The present embodiment relates to a configuration of determining a content of a preliminary ejection in consideration of a temperature of the print head and an environment temperature at a cap closing time, and also of an environment humidity at that time.

In FIG. 7, the process from step S1401 to step S1404 is similar to that from step S1101 to step S1104 shown in FIG. 6 according to the second embodiment, and the process after step S1407 in a case where the negative determination is made at step S1403 is also similar to that after step S1106 shown in FIG. 6.

The content of each of the Preliminary ejection 1, the Preliminary ejection 2, and the Preliminary ejection 3 selected based upon a cap closing time at step S1407 is the same as that of each of the first and second embodiments, and is as follows.

Preliminary ejection 1: 1000 times of ejections/cap closing time is less than six hours.

Preliminary ejection 2: 5000 times of ejections/cap closing time is six hours or more and less than 24 hours.

Preliminary ejection 3: 10000 times of ejections/cap closing time is 24 hours or more.

In a case where at step S1403 as a result of comparison between a temperature of the print head at a cap closing time and a threshold T° C., which is 33° C., it is determined that the temperature of the print head is higher than the predetermined temperature T° C., the process goes to step S1404, wherein it is determined whether or not an environment temperature at a cap closing time is higher than a predetermined threshold Te° C. In a case where the environment temperature is the threshold Te° C. or less, the process goes to step S1407, wherein the process similar to that of each of the first and second embodiments is executed.

In a case where at step S1404 it is determined that the environment temperature at a cap closing time is higher than the threshold Te° C., the process goes to step 1405, wherein it is determined whether or not an environment humidity at a cap closing time is lower than a predetermined threshold He, for example, 15% RH. In a case where the environment humidity is the threshold He or more, the process goes to step S1407, wherein the process similar to that of each of the first and second embodiments is executed.

In a case where the environment humidity at a cap closing time is lower than the predetermined threshold He, the process goes to step S1406, wherein it is determined whether or not a condition that t1 (eight minutes in this example)<cap closing time<t2 (360 minutes in this example) is satisfied. In a case where the condition is not satisfied, the process goes to step S1407.

On the other hand, in a case where the determination condition at step S1406 is satisfied, the process goes to step S1410, wherein the Preliminary ejection 4 is performed. Here, the Preliminary ejection 4 is set in such a manner that the ejection number is larger than that in the Preliminary ejection 1 in the same way as the first and second embodiments. That is,

Preliminary ejection 4: 4000 times of ejections/the cap closing time is eight minutes or more and less than six hours.

As described above, according to the present embodiment, in a case where the temperature of the print head before being closed with the cap is the predetermined temperature or higher, the environment temperature at that time is higher than the predetermined temperature, and the environment humidity is lower than the predetermined humidity, the preliminary ejection (Preliminary ejection 4) more accurately reflecting the degree of increased viscosity of ink in the print head at that time can be performed. As a result, it is possible to prevent occurrence of the ejection failure by the cap closed for a relatively short time.

It should be noted that in the present embodiment also, a table for defining the ejection number of the preliminary ejection for each combination of the head temperature, the environment temperature and the environment humidity may be used.

In the same way as the explanation in the first embodiment, in regard to the preliminary ejection 4, a voltage value or a pulse width of a pulse applied to the electro-thermal conversion element may be made large or an ejection frequency may be made high.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-231279, filed Oct. 21, 2011, which is hereby incorporated by reference herein in its entirety.

What is claimed is:

1. An ink jet printing apparatus having a print head including an ejection opening surface on which a nozzle for ejecting ink is provided, a cap for capping the ejection opening surface, and a preliminary ejection unit configured to cause the print head to eject ink after disengaging the cap from the ejection opening surface, said apparatus comprising:
a control unit configured to control the preliminary ejection unit based on time of capping the ejection opening surface with the cap and temperature of the print head before capping the ejection opening surface with the cap.

2. The ink jet printing apparatus as claimed in claim 1, wherein the higher the temperature of the print head is, the control unit causes the preliminary ejection unit to perform stronger ejection, in a condition that the time of capping is the same.

3. The ink jet printing apparatus as claimed in claim 1, wherein the control unit controls the preliminary ejection unit based on the time of capping the ejection opening surface with the cap, the temperature of the print head, and an environment temperature before capping the ejection opening surface with the cap.

4. The ink jet printing apparatus as claimed in claim 3, wherein the control unit controls the preliminary ejection unit based on the time of capping the ejection opening surface with the cap, the temperature of the print head, the environment temperature, and an environment humidity before capping the ejection opening surface with the cap.

5. A preliminary ejection method for an ink jet printing apparatus having a print head including an ejection opening surface on which a nozzle for ejecting ink is provided, a cap for capping the ejection opening surface, and a preliminary ejection unit configured to cause the print head to eject ink after disengaging the cap from the ejection opening surface, said method comprising:
a temperature measuring step of measuring temperature of the print head before capping the ejection opening surface with the cap;
a time measuring step of measuring time of capping the ejection opening surface with the cap; and
a control step of controlling the preliminary ejection unit based on the temperature of the print head measured in the temperature measuring step and the time of capping measured in the time measuring step.

6. The preliminary ejection method as claimed in claim 5, wherein the higher the temperature of the print head is, the control step causes the preliminary ejection unit to perform stronger ejection, in a condition that the time of capping is the same.
